(19) United States
(12) Patent Application Publication
(10) Pub. No.: US 2005/0194261 A1
(43) Pub. Date: Sep. 8, 2005

(54) Electrochemically activated solutions and a new economical way of producing these solutions

(76) Inventor: Ali Abdullah Hadia, Mississauga (CA)

Correspondence Address: Ali A. Hadia, 1665 Sherwood Forrest Circle, Mississauga, ON, L5K 2G8, CA

(21) Appl. No.: 11/066,528

(22) Filed: Feb. 28, 2005

Related U.S. Application Data
(60) Provisional application No. 60/548,890, filed on Mar. 2, 2004.

(51) Int. Cl. C02F 1/461

(52) U.S. Cl. 205/701; 205/746

(57) ABSTRACT

A solution useful as a corrosion inhibitor, cleaning agent, anti-scaling agent and as an inhibitor of sulfur reducing bacteria is disclosed. This solution consists of an aqueous solution of anolyte with or without the addition of a catholyte. The resulting solution has improved cleaning and de-watering properties making it useful in a variety of industrial applications.

### DRAWINGS

FIG. 1 is a schematic representation of a diaphragmalysis process of electrochemical activation using a diaphragmalysis processor.

FIG. 2. is a schematic comparison between electrolysis and diaphragmalysis.

### INTRODUCTION AND DEFINITIONS

Anew technology has been discovered in the last two or three decades consisting of special Diaphragmalysis devices (processors/reactors) which are used to produce and separate two electrochemically activated solutions, namely an Anodic Solution (Anolyte) and a Cathodic Solution (Catholyte). It has been discovered that these solutions have unique and useful properties.

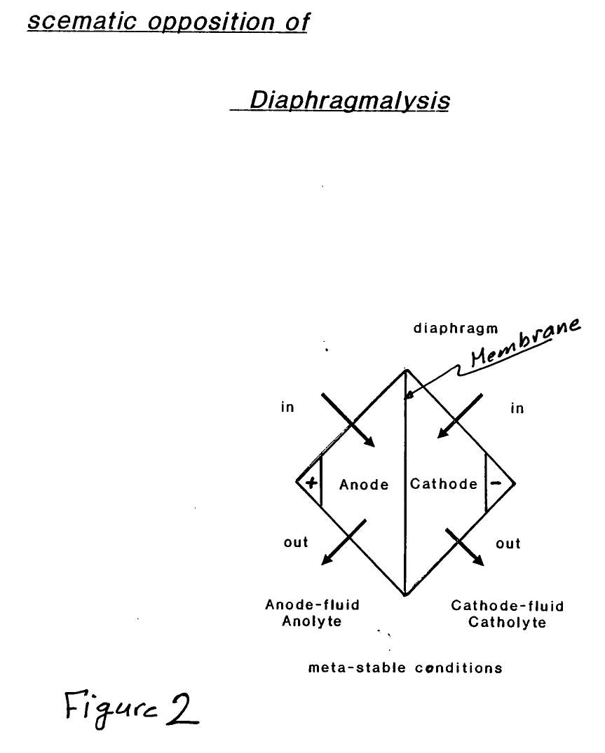

Referring firstly to FIG. 2, a diaphragmalysis (reactor) is the main processor unit which is used in the manufacture of Anolyte and Catholyte solutions via an Electrochemical Activation Process (ECA). The diaphragmalysis reactor (or processor as it is sometimes known) has both an anode and a cathode and a special membrane which allows the two solutions to be transferred separately. Various diaphragmalysis reactors are patented by different companies in different shapes and with different materials under different names in most cases. However, all diaphragmalysis reactors function is substantially the same way all such reactors produce an anodic solution, a catholic solution, or the mixture of both of these solution These reactors (processors) are readily available in the marketplace.

The Anolyte solution is the anodic solution which is produced in the ECA process at the anode. Depending on the water used as feed, it consists of a solution of, but not limited to the following compounds, or species: H₂O, H₂O₂, ClO₂, O₂, O₃, free radicals and may be some others. Anolyte solutions have a PH of 1.5 and up.

The catholyte Solution is the cathodic solution, which is produced in the ECA at the cathode. It consists, but not limited to the following compounds, or species: NaOH, OH, H₂O₂, and may be some others, PH=9 and up.

The Process for Producing Anolyte and Catholyte Solutions:

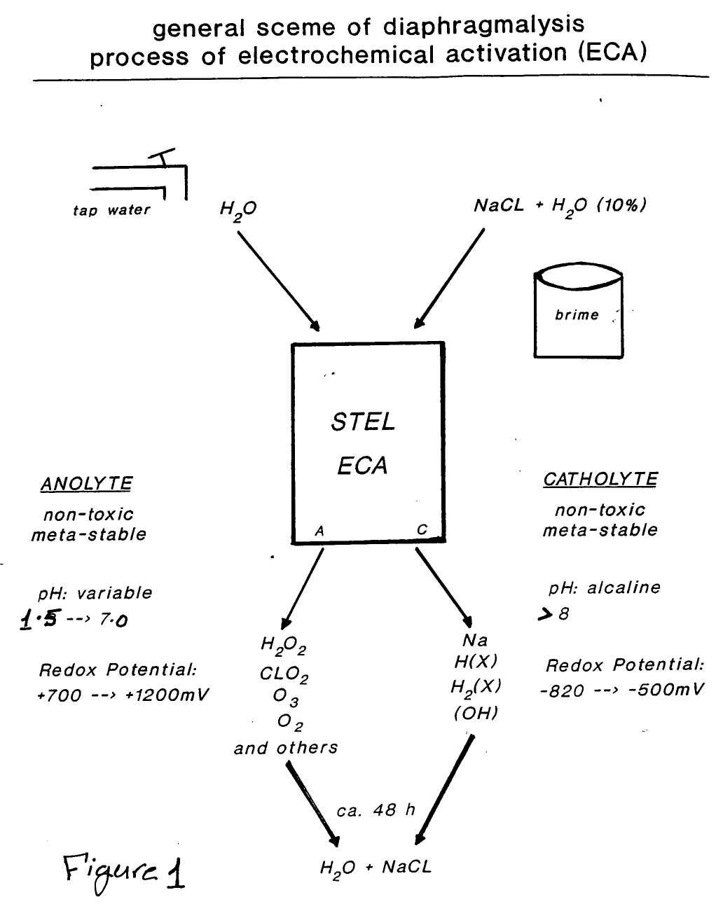

The ECA process is the process where two streams of water and a sodium chloride Solution (or in some cases one mixed stream) go through the diaphragmalysis unit where both of these two are mixed and affected by high-intensity electric field. As a result, the dis-balanced changes in water structure occur and water is enriched in products of electrochemical reactions which results in producing two different solutions (see FIG. 1) and separate solutions at the anode and the cathode, namely Anolyte and Catholyte. (Or in some cases both of these two solution are mixed before) and leave as one neutral solution, depending on the design of the diaphramalysis, or the need of this solution Different commercial names are given to these two products by different Producers. Some of which are Oxilite™ for anolyte and Redolyte™ for Cathlyte solution. Moreover, in our new applications, we refer to the mixed solution of Anolyte and Cathlyte as Biocor-XD™.

Existing Applications for Both Anolyte and Catholyte

The most ongoing applications by most producing/end user companies for this technology are as following:

Anolyte:

Most producing companies or end users use an Anolyte solution as a biocide to kill aerobic bacteria, algae and fungi in drinking and industrial water. Also, Anolyte solutions have been used as a surface disinfectant to disinfect surfaces in medical and dental clinics. It has generally been accepted that the Anolyte solution is not an effective and useful biocide against anaerobic bacteria such as Sulfur Reducing Bacteria (SRB) and Iron Bacteria.

Catholyte:

Catholyte is used as a cleaning solution and as a neutralizer solution to precipitate out poisons dissolved in water.

The Mixed Solution:

Most companies produce the mixture or mix them immediately after producing the solutions to make the resulting product neutral (PH=7+/−) and will use the resulting solutions as disinfectants and sterilizing solutions.

### DETAILED DESCRIPTION OF THE PRESENT INVENTION

Several new, useful and surprising applications have been found for both the Anolyte and Catholyte solutions produced by the electrochemical processors described above. In particular, these solutions have been found to act as excellent corrosion inhibitors, cleaning agents, de-watering agents, de-scaling agents, anti-scaling agents, de-greasing agents and they have also found to be an effective substitute for SRB biocides.

A significant amount of corrosion problems in industry, particularly in the oil industry, are a result of the action of SRB. SRBs cling to the surface of metal items where they produce corrosive byproducts, especially in the presence of polluted water. Ferrous Sulphide (FeS) is a common byproduct of SRB and its presence on the surface of an item is evidence of the action of SRB. Killing the SRB clinging to the surface of metal items will decrease the corrosion of the item; however, few biocides are effective in killing surface clinging SRB.

The Anolyte solution was tested as a potential biocide solution for SRB. Tests were carried out on SRB using the Anolyte solution with polluted water and at different time intervals. The result of those tests showed that the Anolyte was marginally effective in killing SRB only at high Anolyte concentrations and after a long time period. At an Anolyte concentration of 1:200 (1 part anolyte to 200 parts water) significant SRB death was noticed (i.e. from a bacteria count of 1×10⁶ to a bacteria count of 1×10⁵) while at an Anolyte concentration of 1:400 similar SRB death was noticed after two hours. A summary of the testing procedures and results are attached hereto as schedule A. The Anolyte solution seemed ineffective as an SRB biocide at concentration of between 1:600 and 1:800. This indicates that the Anolyte kills SRB only at high anolyte concentrations. However, the study showed that the effect of SRB induced corrosion (indicated by the presence of black ferrous sulphide) ceased even at low Anolyte concentrations. The test were repeated using very low concentrations of the Anolyte solution and it was discovered that the Anolyte was effective in suppressing SRB induced corrosion even at very low anolyte concentrations. The test protocols and results are shown in attachment B. Therefore, it was concluded that the Anoylte was effective at reducing SRB induced corrosion at very low Anoylte concentrations, despite the fact that it did not kill the SRB. Before testing it as biocide on SRB, the Anolye solution was tested to see if it was corrosive at concentrations of 1:1000, 1:800, 1:600 and 1:200. The result showed that at these concentrations, the Anolyte solution itself is not corrosive. Surprisingly, these tests showed that the Anolyte solution inhibits corrosion by between 18 to 30%. (Medium corrosion inhibitor should give above 80% inhibition efficiency while good corrosion inhibitor should give more than 90% of inhibition efficiency).

Given these results, tests were conducted on both the Anolyte and Catholyte solutions as corrosion inhibitors at concentrations of 1:1000, 1:900, 1:800, 1:700, 1:600, 1:400, and 1:200. The result of these tests showed the following:

A—The anolyte showed the following inhibition efficiencies (E) in Static test (see attachments C & D):

Alolyte Concentration

| | |
|---|---|
| At 1:1000 | E = 64% |
| At 1:900 | E 57% |
| At 1:800 | E = 58% |
| At 1:700 | E = 52% |
| At 1:600 | E = 44% |
| At 1:400 | E = 40% |
| At 1:200 | E = 10% |

B—The Catholyte showed the following inhibition efficiencies (E) (see attachments C & D & E)

| | |
|---|---|
| At 1:1000 | E = 73% |
| At 1:900 | E = 64% |
| At 1:800 | E = 47% |
| At 1:700 | E = 58% |
| At 1:600 | E = 83% |
| At 1:400 | E = 86% |
| At 1:200 | E = 17% |

From these results it is clear that the two solutions do work as corrosion inhibitors.

Additional test were carried out on these solutions to test their effectiveness as corrosion inhibitors at lower concentrations of Anolyte (see attachment E) the results of which showed that the Anolyte was an effective corrosion inhibitor at lowered concentrations. These tests were conducted at different temperatures and with different concentration for different dosing repetitions. It was found that the anolyte formed a layer on the steel items as a result of a reaction between the anolyte and the carbon steel. It is postulated that this layer acts as a protective barrier.

The tests showed the following results:

Anolyte Concentration

| | |
|---|---|
| At 2 ppm, | E = 92% |
| At 3 ppm, | E = 90% |
| At 5 ppm, | E = 88% |
| At 8 ppm, | E = 89% |
| At 10 ppm, | E = 85% |
| At 15 ppm, | E = 77% |

All these results were obtained from static tests (see attachment E). From these tests it can be concluded that the Anolyte tested (Biocor-X) and the Catholyte tested (Biocor-D) and the mixture of both (Biocor-XD) do work as effective corrosion Inhibitors.

It was anticipated that Anolyte and Catholyte solutions might be useful in the Dairy industry. Different tests were also conducted on these three solutions, Biocor-X (an Anolyte solution), Biocore-D (a Catholyte solution), and Biocor-XD (a solution of mixed Anolyte and Catholyte) to test the effectiveness of these solutions for different applications in the dairy industry. The solutions Biocor-X and Biocor-XD were subjected to pilot testing on pieces of stainless steel and rubber from a dairy factory to check the side effect of these solutions in order to determine if these solutions had any deleterious side effects which would preclude their use in the dairy industry. As a result of the pilot testing, it was discovered that both Biocor-x and Biocor-XD gave very good results (i.e. that both Biocor-X and Biocor-XD were good cleaning agents). In addition, it was discovered that both solutions cleaned the stainless steel and the rubber gasket much better than the Biocor-D. Further more, both the stainless steel samples and the rubber gasket samples which were treated looked new, clean and shiny. Also, it was discovered that the Catholyte had potential application as an anti-scaling agent because when added to water samples taken from the factory where the pilot test were conducted, most of the dissolved salts in the water samples were precipitated out of solution in the presence of the Catholyte.

As result of these tests, the use of these three different solutions as cleaning solutions for clothing, dishes, floors, glass, and Aluminum, were tested. The results of these subsequent test were as follows:

Effectiveness in Cleaning Oily Dishes:

Both Biocor-X (Anolyte) and Biocor-XD (the mixture of Anolyte and Catholyte) had great effect when used to clean oily dishes and reduced the detergent required by up to 50%. The efficiency of cleaning increases by using hot water. Also, cleaning was much easier than normal and was completed in a shorter time, especially when mechanical cleaning means was applied. The cleaned surfaces appeared new and bright. Biocor-D (Catholyte) did not seem to improve the cleaning effectiveness as significantly as the Anolyte or the mixed solution.

Effectiveness in Cleaning Cloths:

To test the effectiveness of Biocor-X, Biocor-XD, and Biocor-D as a cloths cleaner, four different containers with the same amount of hot water were used. One of the containers was used as a control, and into the remaining three were added Biocor-X, Biocor-XD, and Biocor-D, respectively, in the same ratios. All four containers were used to clean identical samples of towels exposed to the same environment. A quantity of detergent was added to the control and only half as much detergent was added to the three test containers. The results were as follows:

A—Towels washed in containers with BiocorX, and Biocor-XD were much cleaner and had a bright look. Moreover, the dirt and specially sand were found in these two containers much more than other containers. Surprisingly, the towel samples seemed to have absorbed significantly less water compared to the control.

B—The towels which were cleaned in the container with Biocor-D were found to be just as clean as the towels in the control container.

Effectiveness as a Glass Cleaner

The effectiveness of the solutions for cleaning glass was tested. Each test involved two identical pieces of soiled glass, a control and a test. On the control piece a commercially available glass cleaner was used while Biocor-X mixed with hot water was used on the other piece of glass. The test glass (cleaned with Biocor-X) was much cleaner and brighter compared to the control. The same result was found with Biocor-XD. More over, the test pieces which were cleaned with Biocor-X and Biocor-XD did not pick up dust and sand for quite a long time, while the control pieces became dirty and picked up sand particles after a relatively short time.

Effectiveness as a Ceramic Cleaner

The effectiveness of these solutions for cleaning ceramics was then tested. When solutions of Biocor-X and Biocor-XD were used to clean ceramics, the cleaned ceramics were rendered very clean and bright. Furthermore, the cleaned ceramic pieces did not pick up any dirt for several weeks as compared to the control.

From all of these results the following was concluded:

Both Anolyte (Biocor-X) and the mixed (Biocor-XD) solutions appears to act as a corrosion inhibitors for materials such as steel (also perhaps for stainless steel and aluminum). It is believed these solutions react with the steel to form a relatively thick protective film on the steel surface which is relatively non-reactive. This non-reactive film inhibits the corrosion of the underlying surface.

In the case of SRB, while the solutions do not appear to be strong biocides (i.e. they do not appear to kill SRB bacteria at low concentrations) the anolyte solution worked as an effective SRB corrosion inhibitor, even at low anolyte concentrations. It is believed that the SRB bacteria gather together into clusters and the Anolyte (Biocor-X) solution surrounded these clusters with a film. Once encapsulated by the anolyte film, the SRB are much less effective in causing corrosion. For this reason the tests showed the presence of the SRB at low anolyte concentrations even though the SRB could not further produce the ferrous sulphide. Therefore, it is conclude that the Anolyte solution has potential application as an effective SRB corrosion suppressant for use in various industries. The same can be said for Biocor-XD.

It is believed that these solutions (Biocor-X and Biocor-XD) are effective as cleaning agents, de-scaling agents, de-greasing agents, (and the like) for non-reactive surfaces because they form a thin film on various surfaces. For non-reactive surfaces, such as glass or ceramic, the anolye and the mixed solution are believed to form a thin film on the surface which displaces particles of dirt and the like. It is also believed that this thin film acts to smooth out minute surface imperfections and render the surface shiny. It is also believed that the surface film left also acts to prevent minute particles of dirt and dust from adhering to the surface, enabling the treated surface to resist soiling. It is also believed that the anolyte, catholyte and mixed solutions are active as anti-scaling because they form a film on the surfaces which inhibits scale forming particles (Ca, Mg and the like) from adhering to the treated surface.

These solutions also reduce the water used in cleaning and also reduce the energy needed to dewater (dry) cloths and similar washable items. It is believed that the anolyte solution (and the mixed solution) form films on the fibers of the cloths. This film has the effect of displacing dirt and dust particles. This film also seems to have the effect of reducing the water absorbed by the fibers, therefore making it easier to dewater (dry) the fibers.

Therefore, the Anolyte (Biocor-X) and the mixture of Anolyte and Catholyte (Biocor-XD) has application as follows:

For the Anolyte (Biocor-X)
a corrosion Inhibitor,
a biocide substitute for use against SRB and Iron Bacteria,
a scaling inhibitor,
a de-scaling agent which forms a film which spreads on the surface and de-scale any existing scaling,
a glass cleaner and a glass protection application against sand, dust, dirt, and the like,
an energy conservation additive when used in washing machines (due to the fact that it permits the treated clothing to absorb less water). Thus it reduces the time for drying as well as easing the washing and drying rotations,
an energy conservation additive to reduce the energy consumed by pumps (the additive forms a layer which will smooth the motion of flow in pipes and pipe lines due to its low surface tension)
an additive in cooling towers to increase the efficiency of cooling which result in energy savings.
Water conservative due to the fact that they decrease the water used in cloths cleaning.
Degreaser, de-oiling, and de-waxing agent
The anolyte should also have application as an additive for drilling applications, and as an additive for isolating pollutants in water.

The mixed solution of Anolyte and catholyte (Biocor-XD) is also useful for all of the applications mentioned above for the Anolyte solution. The Catholyte solution (Biocor D) is useful as a corrosion Inhibitor and as a scaling inhibitor as it reacts with dissolved scaling elements.

4—Another Economical Way of Producing these Compounds:

During the tests performed on the Anolyte solution (Biocor-X) and the mix solution (BiocorXD), it was discovered that by decreasing the concentrations of salt (NaCl) in the solution, the efficiency of both solutions did not change significantly. From these tests, it is believed that these two solution can be produced by using only water as feed to the processor unit described above or by using a feed consisting of water and some other salt other than NaCl. The new catholyte solution (Biocor-D) produced will have little or no NaCl. Also, the new anolyte solution will have little or no chlorinated compounds. Therefore considering the new produced solutions (without NaCl in the feed stream), namely Anolyte solution (Biocor-X2) and catholyte solution (Biocor-D2) and the mixed solution Biocor-XD2) may have improved effectiveness for use in the same applications mentioned in above. Also, since these improved Anolyte and Catholyte solutions will have little Na and Cl, these solutions should have wide application in the medical and dental fields.

1. A solution for inhibiting the corrosive action of sulfur reducing bacteria comprising an aqueous solution of anolyte.

2. A solution for inhibiting the corrosive action of sulfur reducing bacteria as described in claim 1 comprising an aqueous solution of anolyte and catholyte.

3. An improved solution for cleaning comprising an aqueous solution of anolyte.

4. An improved solution for cleaning as described in claim 3 further comprising an aqueous solution of catholyte and anolyte.

5. An improved solution for de-scaling comprising an aqueous solution of anolyte.

6. An improved solution for de-scaling as defined in claim 5 further comprising a solution of catholyte and anolyte.
